(19) United States
(12) Patent Application Publication
(10) Pub. No.: US 2013/0053003 A1
(43) Pub. Date: Feb. 28, 2013

(54) AUXILIARY DEVICE AND SYSTEM FOR ADDING WEB-BASED MULTIMEDIA APPLICATIONS TO A MULTIMEDIA DEVICE

(71) Applicant: Charles Joseph King, II, Saline, MI (US)

(72) Inventor: Charles Joseph King, II, Saline, MI (US)

(73) Assignee: Toyota Motor Engineering & Manufacturing North America, Inc., Erlanger, KY (US)

(21) Appl. No.: 13/222,863

(22) Filed: Aug. 31, 2011

(51) Int. Cl. H04W 4/00

(52) U.S. Cl. 455/414.1

(57) ABSTRACT

An auxiliary device and system for adding web-based multimedia applications onto a multimedia device through a user's mobile phone is provided. The auxiliary device and system include a housing in electrical communication with the multimedia device. The housing has a processor operable to execute a first application. The first application is operable to access the Internet through the user's mobile phone. The first application includes a list of predetermined numbers of websites. An input is operable to select at least one of a plurality of websites and transmit the data from the website onto the multimedia device.

### FIELD OF THE INVENTION

The invention relates to an auxiliary device and system for selectively adding web-based multimedia applications to a multimedia device. More specifically, the auxiliary device and system provides the web-based applications through a user's mobile phone.

### BACKGROUND OF THE INVENTION

Multimedia devices, commonly referenced as a head unit, may be found on an automotive vehicle. Such head units include media and functional applications such as navigation, CD players, satellite radio, and the like. The applications are often programmed into the head unit, and thus come to the consumer pre-packaged. In order to add additional functions, auxiliary devices such as navigation and CD players may be electronically coupled to the head unit. Accordingly, it remains desirable to have an auxiliary device or system operable to provide users with a choice of web-based multimedia applications for display on the head unit.

### SUMMARY OF THE INVENTION

According to one aspect of the invention, an auxiliary device configured to selectively add web-based multimedia applications to a multimedia device is provided. The auxiliary device is operable to provide the web-based multimedia applications to the multimedia device through a user's mobile phone.

The auxiliary device includes a housing for storing electrical components. The auxiliary device may be in either wired or wireless communication with the multimedia device. For instance, the auxiliary device may be in communication with the multimedia device through a transceiver such as a Bluetooth antenna and receiver operable to transmit and receive data to and from the multimedia device. Alternatively, the auxiliary device may be hardwired to the multimedia device using a universal serial bus connection which is operable to transmit and receive data to and from the multimedia device. The multimedia device is operable and configured to provide various predetermined media applications such as navigation, radio, satellite radio, and the like.

The auxiliary device includes a data processor operable to execute a first application. For use herein, first application refers to an executable software program operable to perform a plurality of functions. The first application is operable to access the Internet through the user's mobile phone. The first application includes a list of predetermined number of websites. The first application may be programmable so as to change the list so as to allow the user to customize the selection of available websites.

An input is operable to actuate the first application and select at least one of the plurality of websites. The data processor may be further operable to transmit data from the input to the selected website so as to allow for the user to manipulate the website. The data processor is further operable to process the website so as to visually display the website onto the display screen of the multimedia device and produce audio sound.

The input may be disposed on one or both of the user's mobile phone or the multimedia device. It should be appreciated by those skilled in the art that manipulation of the website may be done either directly through the user's mobile phone or through the multimedia device.

The auxiliary device may further include a database. The database includes a user's personal information, for use herein personal information includes information which may assist with the identification and verification of the user. The first application is operable to process the database and transmit the user's personal data to the selected website so as to validate the user's identification thus actuating the website in accordance with the user's cached information.

The first application may be stored in either the user's mobile phone or the housing. The first application is further operable to gather the user's personal information stored on the user's mobile phone and the data processor is operable to transmit the user's personal information to the selected website so as to verify the user's identity. Each of the websites stored in the database is configured for operation and validation using the user's personal data.

A system for adding web-based multimedia applications to a multimedia device for use in an automotive vehicle is also provided. The system includes a mobile phone or other mobile device operable to transmit and receive data. Specifically, the mobile phone is operable to transmit and receive data from the internet, and to another auxiliary device. The mobile phone is in communication with an auxiliary device.

The auxiliary device includes a housing having a data processor operable to execute a first application. The auxiliary device is in electrical communication with the multimedia device and with the mobile phone. For instance the auxiliary device may include a wireless transceiver for transmitting data and receiving data such as a Bluetooth transceiver. Alternatively, the auxiliary device may be hardwired to the multimedia device through a universal bus cord.

The first application is operable to access the Internet through the mobile phone. The first application includes a list of predetermined numbers of websites. The first application may be stored in either the mobile phone or the auxiliary device and is operable to gather the user's personal information or process an identification code from the head unit which associates the head unit with a selected user. The personal information is transmitted through the mobile phone to the selected website so as to verify the user's identity.

An input is operable to select at least one of the plurality of websites and actuate the first application. Specifically, the selected website is transmitted through the Internet to a server hosting the selected website wherein the website is retrieved and transmitted in data form to the multimedia device. The user is able to manipulate the selected website using the input through either the mobile phone or the multimedia device.

The system may further include a database having a user's personal information. The personal information from the database may be transmitted to the selected website so as to automatically validate the user's identification and automatically actuate the website in accordance with the user's cached information.

The websites are configured to use cached information, specifically cached user's personal data for validation, user preferences, etc. Alternatively, authentication can be provided at the application level by programming or scripting language or by using cookies, etc. Websites may be limited based on a particular type of content or use. Such websites may include but are not limited to: streaming media sites (Pandora, Grooveshark, Hulu, Youtube, etc.), a news site (CNN.com, etc.), search engines (Google, Yahoo, Bing, etc.), web sites developed only for mobile applications (Google, Pandora, Twitter, Answers, Moviefone, Web on Your Cell, Restaurant Row, etc.), or a web feed to deliver up to the minute headline news, sports information, weather, etc. in an RSS or Atom format to a feed reader/aggregator application on either the mobile phone, auxiliary device, or head unit.

The system may further include a host. The host may be a web-based server operable to retrieve the selected websites and control the download and transmission of information from the website to the mobile phone wherein the website is transmitted through the mobile phone onto the multimedia device. The host may be a dedicated hosting service or dedicated server managed by an Original Equipment Manufacturer, “OEM” or a third party service.

The main purpose of the host includes Internet connectivity and database support, but the host may also serve as a development platform for device and website specific applications. The host may be responsible for application and operating system updates, application management, user management and database management. The host may provide a user interface through which a user may customize his/her profile information. The host may use a single service provider or multiple service provider depending on the systems bandwidth requirements.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a perspective view of the auxiliary device shown in communication with the multimedia device, the mobile phone, and the Internet;

FIG. 2 is a first preferred embodiment of a system for adding web-based multimedia applications to a multimedia device;

FIG. 3 is a second preferred embodiment of a system for adding web-based multimedia applications to a multimedia device using a host;

FIG. 4a is a perspective view of the home page of the multimedia device; and

FIG. 4b is a perspective view showing the examples of various web-based multimedia applications contained in the list.

### DETAILED DESCRIPTION OF THE INVENTION

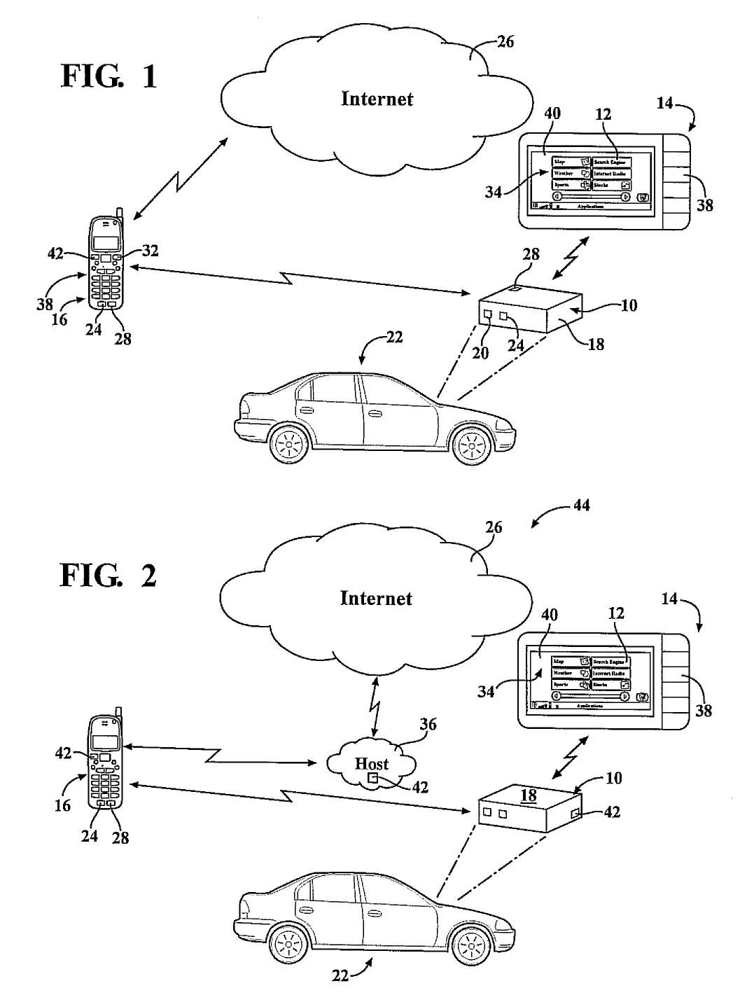

With reference first to FIG. 1, an auxiliary device 10 for adding web-based multimedia applications 12 to a multimedia device 14 through a user's mobile phone 16 is provided. The auxiliary device 10 includes a housing 18. The housing 18 may be formed from a rigid and durable material such as metal. The housing 18 contains electrical components for receiving and managing power, and executing other electrical functions.

The auxiliary device 10 includes a transceiver 20 operable to transmit data either electrically or wirelessly with the multimedia device 14. For instance, the auxiliary device 10 may communicate with the multimedia device 14 either wirelessly or electronically using a Bluetooth transceiver 20 or a USB connection. The auxiliary device 10 may be mounted to the vehicle 22 so as to be easily removed in order to facilitate updates with new hardware, firmware, applications and the like, including Bluetooth hardware/firmware upgrades, either by adding upgrades to the existing auxiliary device 10, or by exchanging the auxiliary device 10 with an different, upgraded device.

It should be appreciated that software applications such as the first application 24 may be updated wirelessly using the existing transceiver 20. Future expansion is not limited to the auxiliary device 10, but the auxiliary device 10 may also be used to update firmware and applications on either of the multimedia device 14 or user's mobile phone 16. By using the auxiliary device 10 to provide multimedia, Internet 26, etc. expansion to the head unit 14, the expense of upgrading the head unit 14 either by the OEM or by the consumer with an aftermarket device is eliminated.

The auxiliary device 10 includes a data processor 28. The data processor 28 may be disposed within the housing 18. The data processor 28 is operable to execute a first application 24. The data processor 28 of the auxiliary device 10 is ideally similar to mobile device processors, in that the processing requirements of a multi-media enabled mobile device are less than that of a larger device like a home PC. The processor of the auxiliary device 10, like mobile chipsets, ideally has a low power consumption. Any mobile chipset currently known in the art may be adaptable for use herein. Illustratively including mobile chipsets employing lower power, reduced instruction set computing (RISC).

The first application 24 may include a set of executable commands operable to access the Internet 26 through the user's mobile phone 16 internet 26 connection. For instance, the mobile phone 16 may be configured to access the internet 26 through a mobile broadband using a known 3GPP standard, (i.e. EV-DO, GPRS), other wireless standards such as WiMAX, mobile WiMAX or Wi-Fi, satellite, etc. Any means of internet 26 connection through a mobile phone 16 may be adaptable for use herein, illustratively including internet 26 connections using data over data transmissions through a Bluetooth. Such connections may be used via the Bluetooth's Personal Area Network (PAN) or Dial-Up Network (DUN), commonly referred to as tethering by those skilled in the art. Alternatively, internet 26 connection may be achieved through voice over data or any other network connection operable to connect with the Internet 26 or a web-based server 30.

The first application 24 further includes a list 32 having a discrete number of websites 34. The first application 24 may be programmable by way of a remote computing device with internet 26 access (Home PC), from the user's web enabled PDA, MP3 player, cell mobile phone 16, etc., from the multimedia device 14 itself via an internal mobile broadband dongle, compact flash or external internet 26 connection such as via the user mobile phone 16/smartmobile phone over Bluetooth either in real time, or through a data push when Internet 26 access becomes available to the multimedia device 14.

In interfacing with the first application 24, a user may be asked to customize the list 32 by selecting from a predetermined number of websites 34 programmed into the first application 24. In turn, the list 32 and other data associated with user's selected websites 34 may be stored on a remote server 30, the user's mobile phone 16 or other mobile device, the auxiliary device 10, or on the memory of multimedia device 14 itself. The URLs are displayed on the multimedia device 14 either through an application present on the host 36, user's mobile phone 16, auxiliary device 10, or multimedia device 14 or any combination thereof.

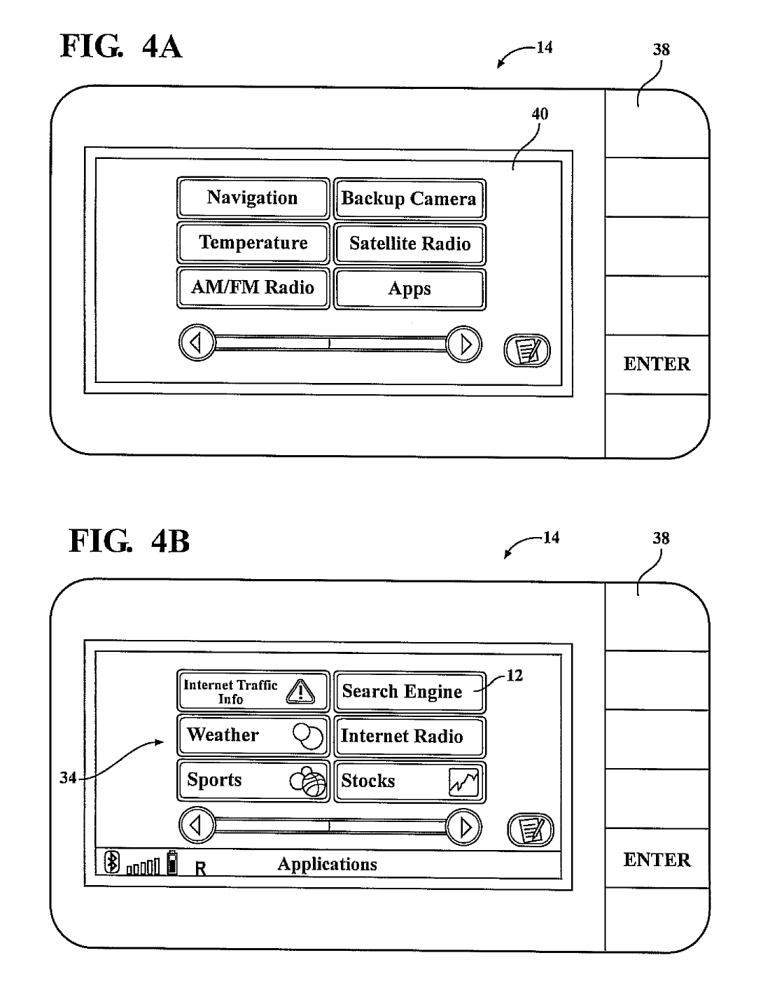

An input 38 is operable to select one of the plurality of websites 34. The input 38 is further operable to actuate the first application 24 wherein the list 32 of websites 34 is made available to the user and displayed on the display screen 40 of the vehicle 22 as shown in FIG. 4b. The user may further actuate the input 38 so as to select one of the websites 34 displayed. The user may select a website 34 using known input 38 devices 10, 14 which may include, but are not limited to user/vehicle 22 interface devices 10, 14 such as: a touch screen on the multimedia device 14; tactile switches, buttons or control knobs located on the multimedia device 14 or in other locations easily accessible to the user, such as controls located on the steering wheel, center console, etc.; voice commands utilizing application programming or through Bluetooth; remote controls; the tactile buttons, switches, and knobs or touch screen located on the user's mobile phone 16 or other mobile device, or on the auxiliary device 10, etc.

As shown in FIG. 4a the display screen 40 has a home page wherein various multimedia functions and vehicle 22 applications may be selected. For illustrative purposes, the user may access the customized list 32 of websites 34 by selecting the window labeled with “Apps.” Selection of the Apps window brings up the list 32 of websites 34 as shown in FIG. 4b.

The websites 34 are listed on the multimedia device 14's display screen 40. For illustrative purposes, the input 38 is shown along the light-hand side of the display and includes a button labeled “Enter” for making the selection. It should be appreciated by those skilled in the art that a user may select from one of the plurality of applications 12, 24 such as CD, nav, or “apps.” Upon selection of “apps,” the first application 24 is actuated and the display shows a plurality of websites 34 available for access. The user may select one of those websites 34 upon which the website 34 is displayed on the multimedia device 14 and the user may manipulate the website 34 using the input 38 auxiliary device 10 on the multimedia device 14 or the input 38 device located on the user's mobile phone 16.

The auxiliary device 10 further includes a database 42. The database 42 may be stored in the housing 18 and includes the user's personal information. The first application 24 is operable to process the database 42 so as to transmit the user's personal data to the selected website 34 thereby validating the user's identification and actuating the website 34 in accordance with the user's cached information.

The database 42 may contain a plurality of personal passwords and logins associated with each of the available websites 34. Upon selection of a website 34, the first application 24 is operable to associate the selected website 34 with the corresponding login information and password of the user.

The first application 24 may be stored in either the user's mobile phone 16 or the auxiliary device 10. In instances where the first application 24 is stored in the user's mobile phone 16, the first application 24 is operable to open up a portal so as to connect the mobile phone 16 with the selected website 34 and transfer data between the mobile phone 16 and the auxiliary device 10 where in turn the auxiliary device 10 transfers the data from the auxiliary device 10 to the multimedia device 14.

In instances where the first application 24 is stored on the auxiliary device 10, the auxiliary device 10 is operable to access the mobile phone 16's area network connection so as to transmit directly through the Internet 26 between the mobile phone 16 and the auxiliary device 10.

The first application 24 may be further operable to gather the user's personal information stored on the user's mobile phone 16 and the data processor 28 is operable to transmit the user's personal information to the selected website 34 so as to verify the user's identity. Alternatively, the first application 24 may be operable to retrieve an identification of the multimedia device 14 and transmit the identification of the multimedia device 14 to the website 34 wherein an association between the multimedia device 14 and the user is made and the user's identification is verified. In such instances each of the plurality of websites 34 is operable to cache a user's personal data for validation.

In operation the auxiliary device 10 is electrically connected to the multimedia device 14 as shown in FIG. 1. Upon actuation of the auxiliary device 10 through an input 38 on the multimedia device 14, the first application 24 is executed and a plurality of web-based multimedia applications 12 is displayed upon the multimedia device 14 screen as shown in FIG. 4. Selection of one of the web-based multimedia applications 12 may be done using an input 38 such as a touch screen, a control knob, or a mouse. Upon selection of the website 34, the first application 24 transmits the selected website 34 to the Internet 26 along with the user's identification so as to validate the user's access to the website 34 and transmits the website 34 through the mobile phone 16 onto the multimedia device 14. Upon validation, data is transmitted to the auxiliary device 10 through the user's mobile phone 16. The data processor 28, processes the data so as to display the website 34 onto the display screen 40 of the multimedia device 14. The user may manipulate the selected website 34 using inputs 38 on either the mobile phone 16 or the multimedia device 14.

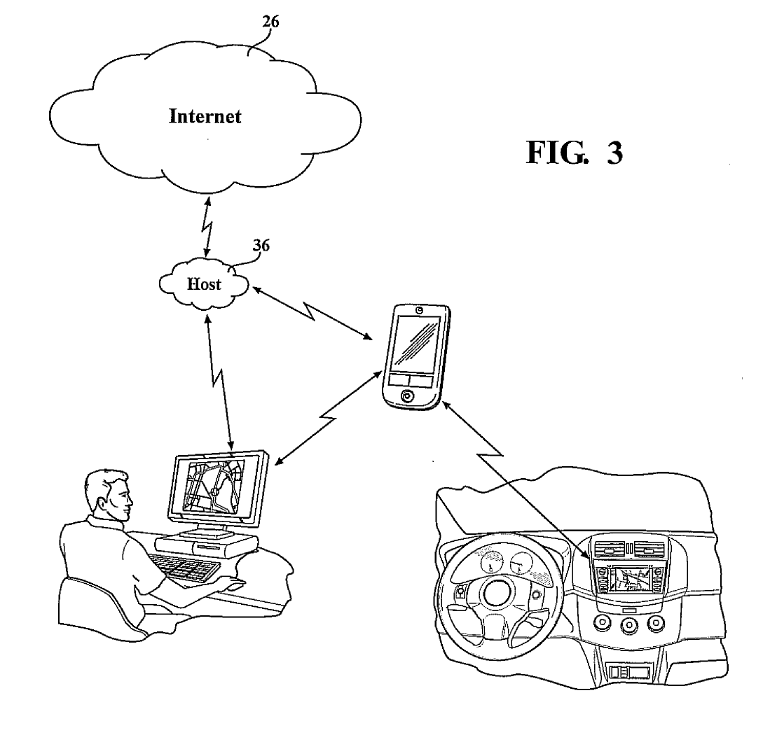

With reference now to FIGS. 2 and 3, a system 44 for adding web-based multimedia applications 12 to a multimedia device 14 for use in an automotive vehicle 22 is provided. With reference first to FIG. 1, a first preferred embodiment of the system 44 is shown. The system 44 includes a mobile phone 16 operable to transmit and receive data from a host 36. The host 36 in turn transmits and receives data from the Internet 26. The host 36 is a web-based server 30 operable to store the user's personal information and to download and transmit and receive data from the mobile phone 16 to the selected website 34. The host 36 is operable to actuate the selected website 34 and transmit the website 34 through the mobile phone 16 onto the multimedia device 14.

The host 36 is operable to facilitate the retrieval of the selected website 34 by configuring the website 34 content for optimal use in a multimedia device 14. For instance, the host 36 may limit data content so facilitate the operation of the website 34 on a limited processing device such as a multimedia device 14 or a mobile phone 16. Further the host 36 may include a database 42 operable to store or cache user information, such as personal identification, user settings, and preferences.

An auxiliary device 10 in electrical communication with the multimedia device 14. A Bluetooth transceiver 20 or a USB connection connects the auxiliary device 10 to the multimedia device 14. The auxiliary device 10 includes a data processor 28 operable to execute a first application 24. The auxiliary device 10 is also in communication with the mobile phone 16. Communication may include wired connections including but not limited to: USB, Firewire, optical cable/fiber, network cable, HDMI cable, serial cable, parallel cable, or vehicle 22 bus standards like VAN, CAN, LIN, MOST, D2B, etc., or the like, or wirelessly using Bluetooth, an. network, Infrared Remote, or other radio signal and the like.

The first application 24 may be disposed on either the mobile phone 16 or the auxiliary device 10. The first application 24 is operable to access the host 36 through the mobile phone 16. The first application 24 includes a list 32 of predetermined numbers of websites 34. The list 32 may be customized by the user though inputs 38 disposed on the user's mobile phone 16.

The system 44 further includes an input 38 operable to select at least one of the plurality of websites 34. The input 38 is further operable to actuate the first application 24 and the data processor 28 is further operable to transmit data from the input 38 to the selected website 34 so as to allow the user to manipulate the website 34.

The system 44 may further include a database 42. The database 42 may be stored on the user's mobile phone 16 or on the auxiliary device 10. Alternatively, the database 42 may be stored on the head unit 14. The database 42 includes the user's personal information. The database 42 may further include the user's login information for each of the respective websites 34 available for selection. The data processor 28 may be further operable to transmit data from the input 38 to the selected website 34 along with the user's identification so as to actuate the website 34 in accordance with the user's cached information.

The first application 24 may be stored in one of either the mobile phone 16 or the auxiliary device 10 and the input 38 may be disposed on one of either the mobile phone 16, the auxiliary device 10, or the multimedia device 14. The first application 24 is operable to gather the user's personal information stored on the mobile phone 16 and the data processor 28 is operable to transmit the user's personal information to the selected website 34 so as to verify the user's identity. Accordingly, the user is logged on to the website 34 and the websites 34 are actuated in accordance with the cached user's personal data.

A non-limiting exemplary first embodiment includes an auxiliary device 10 operable to provide web-based multimedia selected by a user to a multimedia device 14 on an automotive vehicle 22 using only a mobile phone 16. The mobile phone 16 serves as the access point to the Internet 26 and Internet 26 functionality is controlled by any of the mobile phone 16's operating system 44, scripting and programming language of the website 34, and the first application 24. For example, the first application 24 may be programmed to detect pre-programmed websites 34 for use on the multimedia device 14 used by the mobile phone 16. If the user for example has used a particular search engine on his/her mobile phone 16 in the past, this data may be passed from the mobile phone 16 via the auxiliary device 10 to the multimedia device 14 automatically.

Alternatively, upon the installation of the first application 24 onto the user's mobile phone 16, a menu may appear asking the user to choose from the discrete number of available pre-programmed of websites 34 using the mobile phone 16's input 38 keys, touch screen, or voice commands, or the multimedia device 14's input 38. Additionally, the user may customize the list 32 of available websites 34 by deleting any of the pre-programmed websites 34 and replacing it with a website 34 the user desires. Thus the user customizes the list 32 of predetermined numbers of websites 34 available for selection on the multimedia device 14.

In instances where the user uses the mobile phone 16's input 38. The user's selections are in turn are passed to the auxiliary device 10 and then displayed on the multimedia device 14 as touch keys with the selected websites 34′ names, icons, or other identifying indicia, or assigned to tactile keys, switches, etc., which, when pressed provide access to the preselected URL.

In instances where the user utilizes the multimedia device 14 input 38, the selection is transmitted to the auxiliary device 10 and onto the mobile phone 16 wherein the first application 24 transmits the user's selection along with the personal identification to the selected website 34. The selected website 34 is then transmitted from the mobile phone 16 to the auxiliary device 10 and onto the multimedia device 14.

With reference now to FIG. 3, a second preferred embodiment of the system 44 is provided. In the second preferred embodiment the system 44 includes a home personal computer.

In a non-limiting second exemplary embodiment of the invention, a user may customize the list 32 of web-based multimedia applications 12 available for selection on the first application 24 by adding or deleting web-based multimedia applications 12 from the home personal computer. The customized list 32 is stored at the host 36, and is updated on the mobile phone 16 when the mobile phone 16 accesses the host 36.

The host 36 is operable to facilitate the retrieval of the selected web site 34 by configuring the website 34 content for optimal use in a multimedia device 14. For instance, the host 36 may limit data content so facilitate the operation of the website 34 on a limited processing device such as a multimedia device 14 or a mobile phone 16. Further the host 36 may include a database 42 operable to store or cache user information, such as personal identification, user settings, and preferences.

An application at the host 36 may process the user's selections and update the first application 24 to include the user's selections. The selected website 34 is transmitted to the first application 24 wherein the website 34 is processed in the auxiliary device 10 and transmitted for display on the multimedia device 14.

1. An auxilliary device configured to selectively adding web-based multimedia applications to a multimedia auxilliary device through a user's mobile phone, the auxilliary device comprising:
a housing in electrical communication with the multimedia auxilliary device, the housing having a data processor operable to execute a first application, the first application operable to access the internet through the user's mobile phone, the first application having a list of predetermined numbers of websites; and
an input operable to select at least one of the plurality of websites, the input further operable to actuate the first application, the processor further operable to transmit data from the input to the selected website so as to allow for the user to manipulate the website.

2. The auxilliary device as set forth in claim 1, further including a database, the database having a user's personal information, the first application operable to transmit the user's personal data to the selected website so as to validate the user's identification and actuate the website in accordance with the user's cached information.

3. The auxilliary device as set forth in claim 1, further including a BlueTooth antenna and receiver operable to transmit and receive data to and from the multimedia auxilliary device.

4. The auxilliary device as set forth in claim 1, further including a USB connection operable to transmit and receive data to and from the multimedia auxilliary device.

5. The auxilliary device as set forth in claim 1, wherein the first application is stored in either the user's mobile phone or the auxiliary device.

6. The auxilliary device as set forth in claim 1, wherein the input is disposed on one of either the user's mobile phone, or the multimedia auxilliary device.

7. The auxilliary device as set forth in claim 1, wherein the first application is operable to gather the user's personal information stored on the user's mobile phone, the data processor operable to transmit the user's personal information to the selected website so as to verify the user's identity.

8. The auxilliary device as set forth in claim 1, wherein at least one of the plurality of websites require a user's personal data for validation and access.

9. A system for adding web-based multimedia applications to a multimedia auxilliary device for use in an automotive vehicle, the system comprising:
a mobile phone operable to transmit and receive data;
a auxilliary device in electrical communication with the multimedia auxilliary device, the auxilliary device having a data processor operable to execute a first application, the first application operable to access the internet through the mobile phone, the first application having a list of predetermined numbers of websites; and
an input operable to select at least one of the plurality of websites, the input further operable to actuate the first application, the processor further operable to transmit data from the input to the selected website so as to allow for the user to manipulate the website.

10. The system as set forth in claim 9, further including a database, the database having a user's personal information, the first application operable to transmit the user's personal data to the selected website so as to validate the user's identification and actuate the website in accordance with the user's cached information.

11. The system as set forth in claim 9, further including a BlueTooth antenna and receiver operable to transmit and receive data to and from the multimedia auxilliary device.

12. The system as set forth in claim 9, further including a USB connection operable to transmit and receive data to and from the multimedia auxilliary device.

13. The system as set forth in claim 9, wherein the first application is stored in either the mobile phone or the auxilliary device.

14. The system as set forth in claim 9, wherein the input is disposed on one of either the mobile phone, or the multimedia auxilliary device.

15. The system as set forth in claim 9, wherein the first application is operable to gather the user's personal information stored on the mobile phone, the data processor operable to transmit the user's personal information to the selected website so as to verify the user's identity.

16. The system as set forth in claim 9, wherein each of the plurality of websites are operable to cache a user's personal data for validation.

17. The system as set forth in claim 9, further including a host, the host operable to receive and transmit data to and from the mobile phone and the interne, the host retrieving the selected website and managing validation of the selected website so as to enable the user to access the website.
